(19) United States
(12) Patent Application Publication
(10) Pub. No.: US 2019/0149987 A1
(43) Pub. Date: May 16, 2019

(54) SECONDARY DEVICE SETUP

(71) Applicant: Amazon Technologies, Inc., Seattle, WA (US)

(72) Inventor: Jordan Ryan Moore, Gig Harbor, WA (US)

(21) Appl. No.: 15/809,695

(22) Filed: Nov. 10, 2017

(51) Int. Cl. H04W 12/06; H04W 12/08; H04W 76/02; G06F 3/16

(52) U.S. Cl. CPC H04W 12/06; H04W 12/08; H04W 84/12; G06F 3/167; H04W 76/02

(57) ABSTRACT

A secondary device may be setup with minimal user interaction in circumstances where a first device is already setup in an environment where the two devices are located. The first device may determine that a second device needs to be setup, and, in response, send a request to a remote system requesting a temporary authentication token that the second device can use to set itself up. Upon receipt of the temporary authentication token from the remote system, the first device may retrieve network credentials it maintains in local memory, and may send the temporary authentication token and the network credentials for receipt by the second device for use in setting up the second device. The second device may initiate a setup mode and receive the temporary authentication token and the network credentials from the first device, which may then be used to complete the setup of the second device.

### BACKGROUND

As computing devices evolve, so do the ways users are able to interact with them, such as through mechanical devices (e.g., keyboards, mice, etc.) and touch screens. Other ways to interact with computing devices are through natural language input using speech, and computer vision-based input using gestures and movements. As a result, many of today's computing devices are “headless,” meaning that they do not include a display, and the primary form of user input may be voice and/or gestural input instead of more familiar mechanisms like touch screens. Many of today's computing devices also typically rely on remote computing resources in order to access services from “the Cloud.” Often, a device must be setup in order to access these Cloud-based services by connecting the device to a private WiFi network, and subsequently registering the device with a user account maintained by a service provider.

However, when it comes to setting up a device for the first time, users often find it difficult to register headless devices that have no display. There may be various reasons for this, but much of the difficulty stems from the fact that a user must own a smart device (e.g., a phone or a tablet), download a mobile application to the smart device, and then setup the headless device using the downloaded mobile application. In this scenario, the user may experience difficulties if the mobile application does not discover the headless device. Even if the mobile application discovers the headless device, the user may be required to type his/her WiFi password into the mobile application, which is oftentimes something that the user cannot recall because most users setup a WiFi access point (AP) by creating a WiFi password, and then they forget the password due to the fact that they are seldom required to recall the password. Even if a user remembers or retrieves the WiFi password, it may constitute a lengthy, random sequence of letters, numbers, and/or symbols that is difficult to type without user error. Thus, existing techniques for setting up devices are cumbersome, involve several complicated steps, and cause user frustration as a result.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1A is a schematic diagram of an illustrative system architecture that includes a first device configured to obtain setup information for a second device, and to transmit the setup information to the second device so that the second device can use the setup information to complete a setup procedure.

FIG. 1B is a schematic diagram of the illustrative system architecture of FIG. 1A in which the second device uses setup information it received from the first device to complete the setup procedure.

FIG. 2 illustrates a functional block diagram of computer components implemented at a client device, which may represent the first device or the second device of FIGS. 1A and 1B.

FIG. 3 illustrates a functional block diagram of computer components implemented at a computing device(s) of a remote system.

FIG. 4 is a flow diagram of an illustrative process for setting up a secondary device.

FIG. 5 is a flow diagram of an illustrative process for the first device determining that a second device needs to be setup.

FIG. 6 is a flow diagram of another illustrative process for the first device determining that a second device needs to be setup.

FIG. 7 is a flow diagram of an illustrative process for the first device sending, and the second device receiving, network credentials and a temporary authentication token for use in setting up the second device.

FIG. 8 is a flow diagram of another illustrative process for the first device sending, and the second device receiving, network credentials and a temporary authentication token for use in setting up the second device.

FIG. 9 is a flow diagram of another illustrative process for the first device sending, and the second device receiving, network credentials and a temporary authentication token for use in setting up the second device.

FIG. 10 is a flow diagram of an illustrative process for the first device verifying an authorized user and/or an authorized secondary device before proceeding with the setup of the second device.

FIG. 11 is a flow diagram of an illustrative process for the first device conserving resources in regards to broadcasting network credentials and a temporary authentication token, and terminating a setup procedure for the second device.

FIG. 12 is a flow diagram of an illustrative process for notifying a user of a successful setup, and the secondary device receiving a permanent authentication token, and accessing one or more services from a remote system using the permanent authentication token.

### DETAILED DESCRIPTION

This disclosure is directed to, among other things, systems, devices, and techniques for setting up a secondary device in circumstances where a first device is already setup in an environment where the first and second devices are located. “Setting up,” as used herein, means configuring a device to access a local area network (LAN), and to register the device with a user account for accessing one or more services provided by a remote system over a wide area network (WAN). Accordingly, at a time when a secondary device is to be setup, a first device may already be setup in an environment where the first and second devices are located. For example, the first device may have previously obtained access to a LAN, and may have previously registered with a user account of a user in order to access one or more services from a remote system over a WAN. After setup, the first device may maintain, in local memory of the first device, network credentials for accessing the LAN, and an authentication token that can be used to authenticate the first device with the remote system for accessing services therefrom.

Initially, the first device may determine that a second device needs to be setup. This determination can be made in various ways, as described below with respect to various embodiments. In response to determining that the second device needs to be setup, the first device may send a request via a wireless access point (WAP) and over a WAN to a remote system requesting a temporary authentication token. The first device may use the network credentials maintained in local memory of the first device to access the LAN, which allows the first device to send the request to the remote system. Furthermore, because the first device is already registered with the user account (and thereby authorized to communicate with the remote system), the first device may receive the temporary authentication token from the remote system. The first device (now in possession of the temporary authentication token) may retrieve the network credentials from local memory of the first device, and the first device may send the temporary authentication token and the network credentials for receipt by the second device so that the second device can use the token and the network credentials to setup the second device. The temporary authentication token and the network credentials can be sent in various ways, as described below with respect to various embodiments. It is to be appreciated that, because the second device may not be able to access the LAN before it comes into possession of the network credentials, the transmission of the temporary authentication token and the network credentials from the first device to the second device occurs using an alternative technique that does not include transmission over the LAN.

The second device, while in a setup mode, may receive the temporary authentication token and the network credentials from the first device. The second device (now in possession of the temporary authentication token and the network credentials) may access the LAN using the network credentials, and may send a request to the remote system to register the second device with the user account using the temporary authentication token. Upon successful registration with the user account, the second device may complete the setup and may access one or more services from the remote system.

By employing the techniques and systems described herein, a setup process for a secondary device can be simplified or streamlined, as compared to existing techniques for setting up networked computing devices. As noted above, downloading a mobile application, recalling a password (which may be difficult to remember), and typing the password (which may be lengthy and difficult to type without user error) into a computing device can present difficulties. In some cases, a user may be unable to setup a device using such existing setup procedures that are cumbersome and difficult for many users. The techniques and systems described herein allow for setting up a secondary device with minimal user interaction, without the user having to own a smart device (e.g., a smart phone or tablet), and without the user having to recall and type network credentials (e.g., a password) into a computing device. This simplifies the setup process for a secondary device, making it easy for a user to begin using a recently purchased device without difficulty in setting it up.

Other features disclosed herein are directed to security measures that ensure an unauthorized user and/or device cannot be setup using the techniques described herein, as well as resource conservation measures that allow the first and/or second device in the environment to conserve resources with respect to communications bandwidth resources, processing resources, memory resources, power resources, and/or other computing resources. For purposes of discussion, examples are used herein primarily for illustrative purposes. Furthermore, the techniques described herein may be utilized to register a secondary device that is headless (i.e., a device that does not have a display), yet, it is to be appreciated that the techniques described herein may be implemented to register any suitable type of networked computing device, including those that include a display or multiple displays.

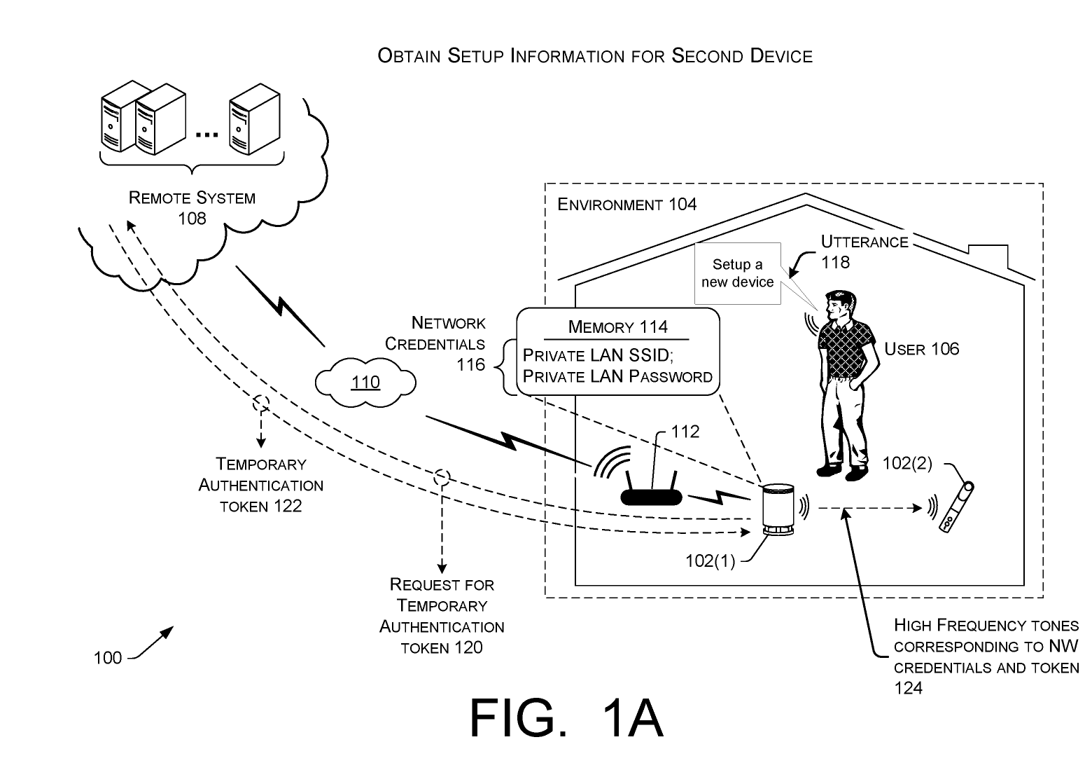

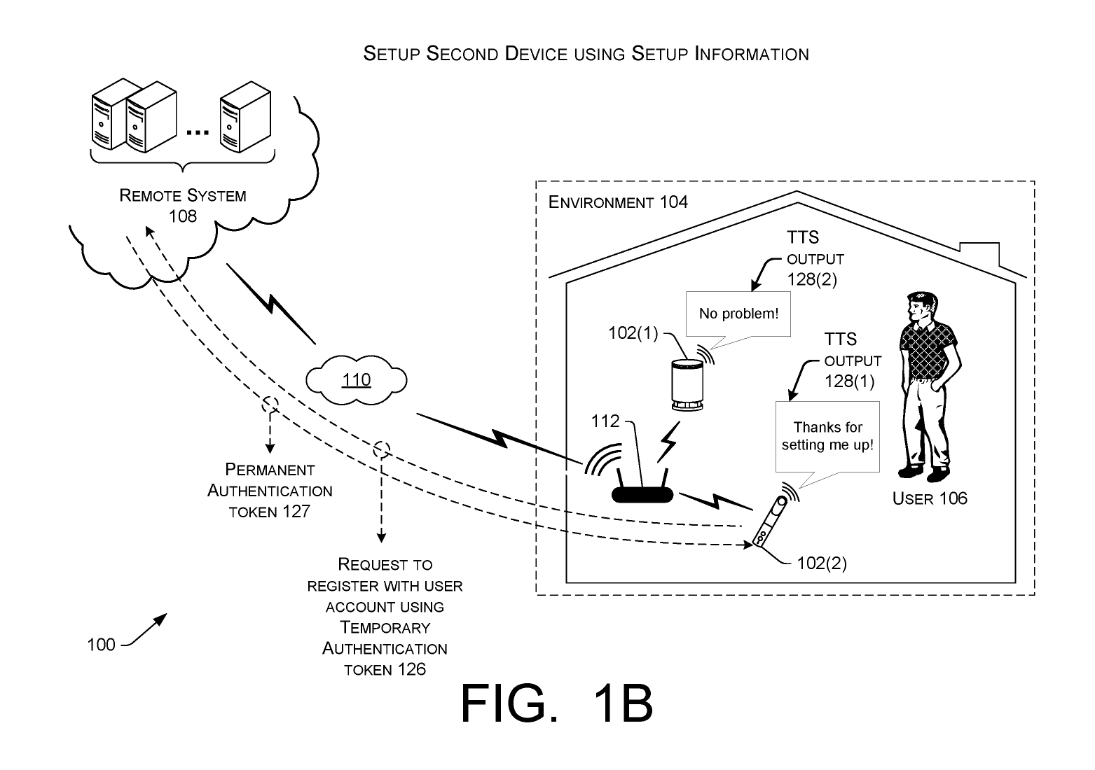

FIG. 1A is a schematic diagram of an illustrative system architecture 100 that includes a first device 102(1) configured to obtain setup information for a second device 102(2), and to transmit the setup information to the second device 102(2) for the second device 102(2) to use in completing a setup procedure. The first device 102(1) and the second device 102(2) may be collocated within an environment 104, meaning that the first device 102(1) and the second device 102(2) are within a threshold distance of each other. Depending on the communications protocols and data transmission techniques employed to transmit setup information from the first device 102(1) to the second device 102(2), this threshold distance may vary. The environment 104 can include any suitable area where one or more devices 102, such as the first device 102(1) and the second device 102(2), are located. FIGS. 1A and 1B show an example of an environment 104 comprising a house, which may represent a place of residence of a user 106 who owns the devices 102(1) and 102(2). However, the environment 104 is not limited to a house. Rather, the environment 104 may comprise any physical structure, such as a building, a house, or a similar structure, and/or the environment 104 can comprise an outdoor environment 104, or a partially outdoor environment 104. It is to be appreciated that FIGS. 1A and 1B are provided to aid in comprehension of the disclosed techniques and systems. As such, it should be understood that the discussion herein is non-limiting.

In some embodiments, the user 106 may control one or more of the devices 102 within the environment 104 by using voice commands and/or gestures that are detected by the individual devices 102. For instance, if the user 106 would like to play music on the first device 102(1), the user 106 may issue a voice command to the first device 102(1) to “play music by Joe Songbird”. The first device 102(1) may, in response to the voice command, interact with a remote system 108 by transmitting/receiving data over a wide area network (WAN) 110 to cause the device 102(1) to perform the requested operation with the assistance of the remote system 108.

The network 110 is representative of many different types of networks, and may include wired and/or wireless networks that enable communications between the entities in the environment 100. In some embodiments, the network(s) 110 may include cable networks, the Internet, wide area networks (WAN), mobile telephone networks (MTNs), and other types of networks, possibly used in conjunction with one another, to facilitate communication between the remote system 108 and the devices 102. Although embodiments are described in the context of a web based system, other types of client/server-based communications and associated application logic could be used.

Accordingly, the remote system 108 may generally refer to a network-accessible platform—or “Cloud-based service”—implemented as a computing infrastructure of processors, storage, software, data access, and so forth that is maintained and accessible via the network 110, such as the Internet. Cloud-based services may not require end-user knowledge of the physical location and configuration of the system that delivers the services. Common expressions associated with cloud-based services, such as the remote system 108, include “on-demand computing”, “software as a service (SaaS)”, “platform computing”, “network accessible platform”, and so forth. Music streaming is just one example service that may be provided by the devices 102 with access to the remote system 108. Other services provided by the remote system 108 may include, without limitation, question and answer services, electronic commerce (ecommerce) services, gaming services, telephony services, smart home services, and the like.

In order to access one or more services from the remote system 108, the devices 102 may go through a setup procedure that configures the devices 102 to access a LAN, and that causes the devices 102 to register with a user account for accessing one or more services provided by the remote system 108. The LAN that is available in the environment 104 for the devices 102 to access may be a private (or secure) LAN (e.g., a local wireless (WiFi) network) that requires a password for access thereto, or the LAN may be a public LAN that does not require a password for access thereto. In FIG. 1A, the first device 102(1) is already setup, meaning that the first device 102(1) has access to a LAN in the environment 104, which enables the first device 102(1) to send/receive data to/from the remote system 108 via a wireless access point (WAP) 112 that couples the first device 102(1) to network devices of the network 110 (also referred to herein as a “WAN” 110). Accordingly, the local memory 114 of the first device 102(1) is shown as storing network credentials 116 (e.g., a service set identifier (SSID) and a password of a private LAN) that can be used by the first device 102(1) for accessing the remote system 108 over the WAN 110. It is to be appreciated that, in the case of a public LAN, the network credentials 116 may include a SSID for the public LAN, and may omit a password, seeing as how a public LAN does not require a password for access thereto. The already-setup first device 102(1) may have been previously assigned an authentication token that the first device 102(1) is configured to use when authenticating itself with the remote system 108 for access to services provided by the remote system 108.

The second device 102(2) in FIG. 1A may represent a device that is not yet setup. For example, this could be a device that the user 106 recently purchased and would like to use within the environment 104. Out of the box, the second device 102(2) may not yet be configured to access services from the remote system 108 because it does not have the requisite network credentials 116 to access the LAN in the environment 104, and it does not have an authentication token to authenticate itself with the remote system 108.

In order to setup the second device 102(2) with minimal interaction from the user 106, the user 106 may, for example, speak an utterance 118 (e.g., “Setup a new device”). In some configurations, the first device 102(1) may be configured to identify a predefined “wake word” (i.e., a predefined utterance) before acting on any detected utterance 118 in the environment 104. In response to the utterance 118 (possibly with the predefined “wake word”), a microphone(s) of the first device 102(1) may detect input audio based on the utterance 118 spoken by the user 106 (e.g., by identifying the predefined “wake word” in the utterance 118), and may process audio data corresponding to the detected input audio to determine that a secondary device needs to be setup. The first device 102(1) may be configured to process the audio data locally (e.g., using automated speech recognition (ASR) and natural language understanding (NLU) engines) to make this determination, and/or the first device 102(1) may be configured to send the audio data to the remote system 108, which may determine, using similar techniques “in the Cloud,” that a secondary device needs to be setup. In the latter scenario, the remote system 108 may send a command to the first device 102(1) so that the first device 102(1) can determine, from the command received from the remote system 108, that a secondary device needs to be setup. Alternative techniques for the first device 102(1) determining that a secondary device needs to be setup are discussed below with reference to the following figures. FIG. 1A illustrates an example technique of making this determination based on a voice command spoken by the user 106.

In response to determining that a secondary device needs to be setup, the first device 102(1) may be configured to send a request 120 via the WAP 112 and over the WAN 110 to the remote system 108 requesting a temporary authentication token. The first device 102(1) (being authenticated with the remote system 108) may then receive the temporary authentication token 122 from the remote system 108 over the WAN 110 and via the WAP 112. As discussed in more detail below, this temporary authentication token 122 may be a number of bytes that is below a threshold amount of data so that the temporary authentication token 122 can be transmitted from the first device 102(1) to the second device 102(2), which may be under communication bandwidth constraints due to available data transmission techniques and/or protocols employed for its transmission in the environment 104. Thus, the token 122 may be a “temporary” token that is used for setting up the secondary device 102(2), but is then replaced by a permanent authentication token that the secondary device 102(2) can use for accessing the remote system 108 going forward.

With the temporary authentication token 122 in hand, the first device 102(1) may retrieve the network credentials 116 from the local memory 114 of the first device 102(1). Notably, this eliminates the need for the user 106 to recall and type the password for a private LAN into a computing device. The first device 102(1) may then send the temporary authentication token 122 and the network credentials 116 for receipt by the second device 102(2) and for use by the second device 102(2) in completing the setup procedure.

As mentioned, the setup information (e.g., the temporary authentication token 122 and the network credentials 116) can be sent from the first device 102(1) to the second device 102(2) in various ways, as described herein with respect to various embodiments. FIG. 1A illustrates an example where high frequency audio (HFA) (sometimes referred to as “high frequency sound” or “ultrasonic communication”) is used to send the setup information to the second device 102(2). Sending information or data over HFA may include the first device 102(1) transforming the information/data into an audio signal, and outputting the audio signal as a series of tones via a speaker(s) of the first device 102(1), where the series of tones are output at a frequency that is inaudible to the human ear. The frequency at which tones are output using HFA may be greater than a threshold frequency (e.g., greater than about 20 kilohertz (kHz)). In this manner, humans in the vicinity of the device 102 that is outputting the tones are unable to hear the tones. Accordingly, FIG. 1A illustrates an example where the first device 102(1) outputs high frequency tones 124 that correspond to the setup information (e.g., the temporary authentication token 122 and the network credentials 116). In this scenario, a speaker(s) of the first device 102(1) is used as a wireless data transmission component to broadcast the setup data/information, and a microphone(s) of the second device 102(2) is used as a wireless data reception component to detect the broadcast tones so that the second device 102(2) can derive the setup data/information from the detected tones.

FIG. 1B is a schematic diagram of the illustrative system architecture 100 of FIG. 1A in which the second device 102(2) uses setup information it received from the first device 102(1) to complete the setup procedure. FIG. 1B continues from FIG. 1A, and assumes that the second device 102(2) has received the setup information (e.g., the temporary authentication token 122 and the network credentials 116) from the first device 102(1), as described with reference to FIG. 1A. It is also assumed, in FIGS. 1A and 1B, that the user 106 has powered on the second device 102(2) such that the second device 102(2), in response to being powered on (e.g., the device 102(2) being plugged in and/or receiving user input to power the device 102(2) on), may initiate a setup mode, and receive the setup information, as described with reference to FIG. 1A.

As shown in FIG. 1B, the second device 102(2) may access the LAN in the environment 104 using the network credentials 116 it received from the first device 102(1), as described in FIG. 1A. This may involve identifying an SSID from the network credentials 116 that the WAP 112 makes available to devices 102 in the environment 104 (and, in the case of a private LAN, providing the password from the network credentials 116 to the WAP 112) in order to connect to the LAN. With access to the LAN, the second device 102(2) may then send a request 126 via the WAP 112 and over the WAN 110 to the remote system 108 requesting to register the second device 102(2) with the user account of the user 106, using the temporary authentication token 122. In some embodiments, the second device 102(2) may receive a permanent authentication token 127 that replaces the temporary authentication token 122 in order to complete the setup of the second device 102(2), although the temporary authentication token 122 may alternatively be utilized as a permanent authentication token, in some configurations. After successfully setting up the second device 102(2), the second device 102(2) may emit a first text-to-speech (TTS) output 128(1) from a speaker(s) of the second device 102(2) (e.g., “Thanks for setting me up!”), and a microphone of the first device 102(1) may detect this first TTS output 128(1) (possibly with the inclusion of a predefined “wake word” in the first TTS output 128(1)), and respond by emitting a second TTS output 128(2) from a speaker(s) of the first device 102(1) (e.g., “No problem!”). The first TTS output 128(1) may be triggered by a command received, by the second device 102(2), from the remote system 108. The remote system 108 may send this command in response to a successful registration or setup of the second device 102(2). This command (instructing the second device 102(2) to output the first TTS output 128(1)) may be sent together with, or separately from, the permanent authentication token 127. The second TTS output 128(2) may be output by the first device 102(1) in response to the first device 102(1) capturing, via a microphone, audio data corresponding to the first TTS output 128(1), and sending the audio data to the remote system 108, which may process the audio data using ASR and NLU techniques to determine a command for the second TTS output 128(2). Alternatively, the first device 102(1) may process the audio data locally using onboard ASR and NLU engines. In this manner, the second TTS output 128(2) may be triggered by the command received, by the first device 102(1), from the remote system 108. These TTS outputs 128 from the devices 102(1) and 102(2) in the environment 104 may serve as a user notification that lets the user 106 know that the setup of the second device 102(2) was successful, while doing so in a fun and entertaining way.

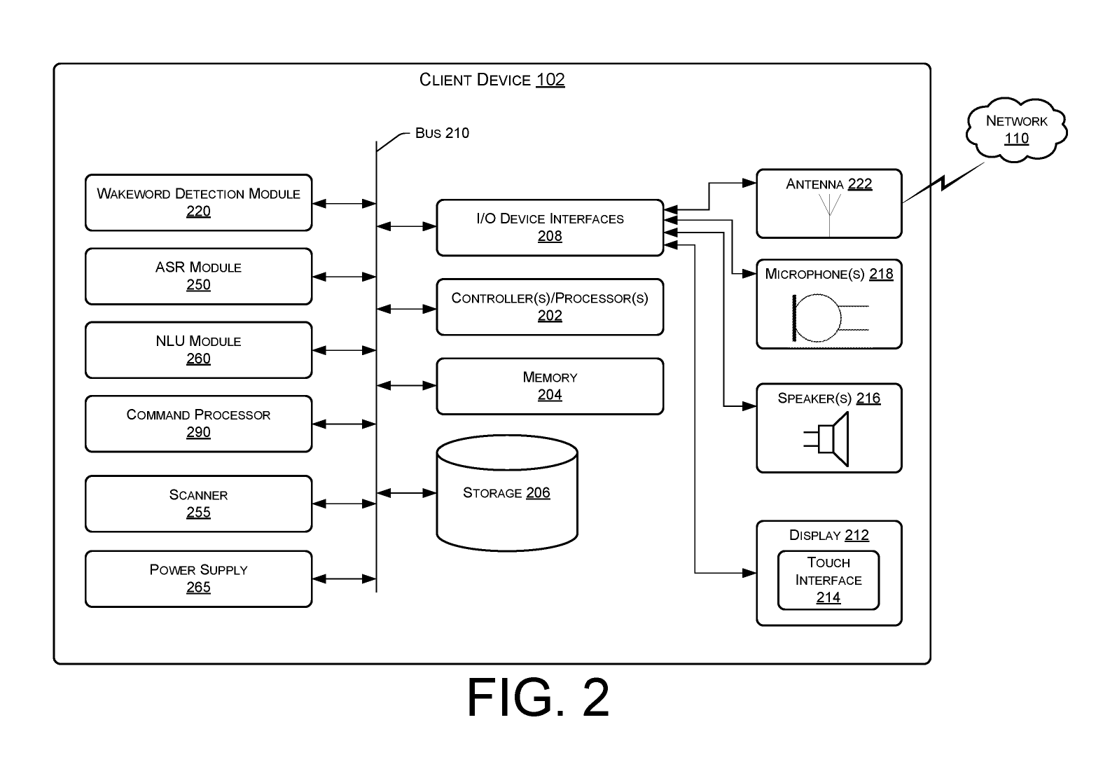

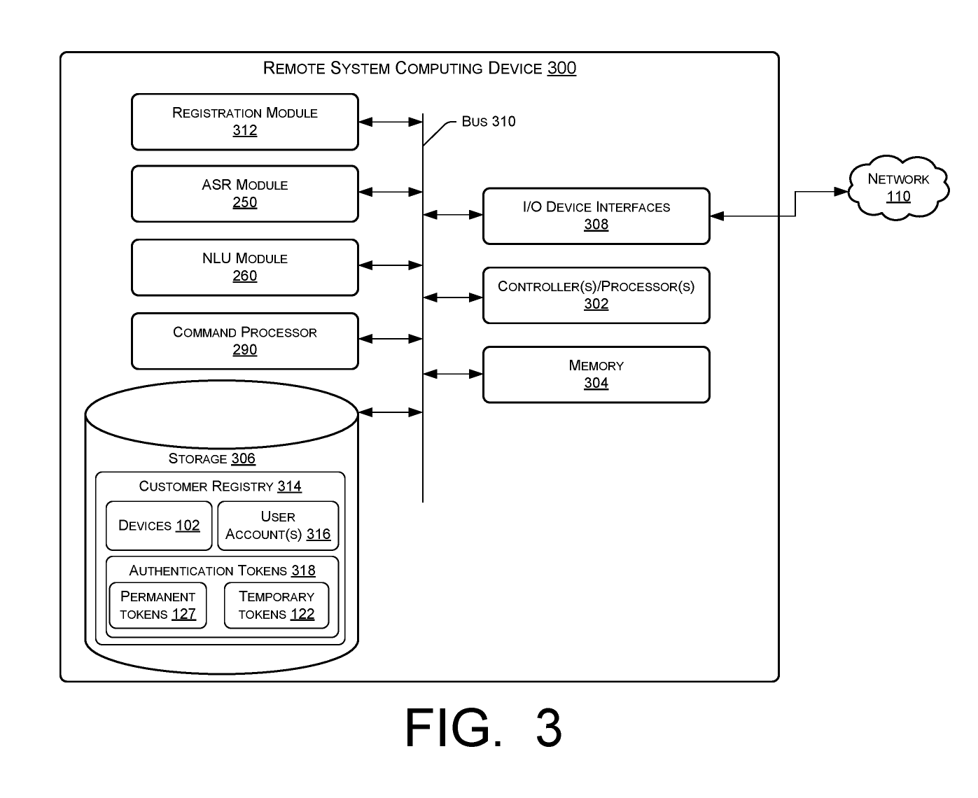

FIG. 2 is a block diagram conceptually illustrating example components of a client device 102, which may represent the first device 102(1) or the second device 102(2) of FIGS. 1A and 1B. FIG. 3 is a block diagram conceptually illustrating example components of a remote computing device 300 of the remote system 108 of FIGS. 1A and 1B. Multiple such computing devices 300 may be included in the remote system 108. In operation, individual devices (102/300) may include computer-readable and computer-executable instructions that reside on the respective device (102/300), as will be discussed further below.

Individual devices (102/300) may optionally include one or more controllers/processors (202/302), which may individually include a central processing unit (CPU) for processing data and computer-readable instructions, and may optionally include a memory (204/304) for storing data and instructions of the respective device. The memories (204/304) may individually include volatile random access memory (RAM), non-volatile read only memory (ROM), non-volatile magnetoresistive (MRAM) and/or other types of memory. Individual devices (102/300) may also optionally include a data storage component (206/306), for storing data and controller/processor-executable instructions. The data storage component may individually include one or more non-volatile storage types such as magnetic storage, optical storage, solid-state storage, etc. Individual devices (102/300) may also be connected to removable or external non-volatile memory and/or storage (such as a removable memory card, memory key drive, networked storage, etc.) through respective input/output device interfaces (208/308). Embodiments may be provided as a computer program product including a non-transitory machine-readable storage medium having stored thereon instructions (in compressed or uncompressed form) that may be used to program a computer (or other electronic device) to perform processes or methods described herein. The machine-readable storage medium may include, but is not limited to, hard drives, floppy diskettes, optical disks, compact disc read-only memories (CD-ROMs), digital video discs (DVDs), read-only memories (ROMs), random access memories (RAMs), erasable programmable read-only memories (EPROMs), electrically erasable programmable read-only memories (EEPROMs), flash memory, magnetic or optical cards, solid-state memory devices, or other types of media/machine-readable medium suitable for storing electronic instructions. Further, embodiments may also be provided as a computer program product including a transitory machine-readable signal (in compressed or uncompressed form). Examples of machine-readable signals, whether modulated using a carrier or not, include, but are not limited to, signals that a computer system or machine hosting or running a computer program can be configured to access, including signals downloaded through the Internet or other networks. For example, distribution of software may be by an Internet download.

Computer instructions for operating individual devices (102/300) and its various components may be executed by the respective device's controller(s)/processor(s) (202/302), using the memory (204/304) as temporary “working” storage at runtime. A device's computer instructions may be stored in a non-transitory manner in non-volatile memory (204/304), storage (206/306), or an external device(s). Alternatively, some or all of the executable instructions may be embedded in hardware or firmware on the respective device in addition to or instead of software.

Individual devices (102/300) may optionally include input/output device interfaces (208/308). A variety of components may be connected through the input/output device interfaces (208/308), as will be discussed further below. Additionally, individual devices (102/300) may optionally include an address/data bus (210/310) for conveying data among components of the respective device. Individual components within a device (102/300) may also be directly connected to other components in addition to (or instead of) being connected to other components across the bus (210/310).

Referring to the device 300 of FIG. 3, the device 300 may optionally include a registration module 312 that is configured to assist with aspects of the setup procedure for the secondary device 102(2), as described herein. The registration module 312 can represent one or more services and/or one or more application programming interfaces (APIs) configured to implement the functions and techniques described herein with reference to the registration module 312. In an example, the registration module 312 may be configured to receive requests 120 from an already-registered device, such as the first device 102(1) of FIGS. 1A and 1B, may respond by sending a temporary authentication token 122 to a requesting, already-registered device 102, and may receive requests 126 from secondary devices, such as the secondary device 102(2), requesting to register with a user account using a previously provisioned temporary authentication token 122.

The storage 306 may maintain a customer registry 314 for each customer/user 106. The customer registry 314 may include the devices 102 registered to the user 106, as well as a user account(s) 316 associated with a user 106. In this manner, the remote system 108 maintains a mapping from registered devices 102 to the user 106. The storage 106 may also maintain authentication tokens 318, sometimes referred to as “authentication codes” 318, “authorization codes/tokens” 318, or “registration codes/tokens” 318. These tokens 318 may include both permanent tokens 127 and temporary tokens 122, the temporary tokens 122 often being smaller in size (e.g., measured in bytes or bits), and meant to be used temporarily for setup/registration purposes.

Referring again to the client device 102 shown in FIG. 2, the device 102 may optionally include a display 212, which may optionally comprise a touch interface 214. Or the device 102 may be “headless” and may primarily rely on spoken commands, and/or gestural commands, for input. As a way of indicating to a user 106 that a secondary device 102(2) has been setup successfully, the device 102 may be configured with a visual indicator, such as a light emitting diode (LED) or similar component (not illustrated), that may change color, flash, or otherwise provide visual indications by the device 102. The device 102 may also optionally include input/output device interfaces 208 that connect to a variety of components such as an audio output component such as a speaker 216 (which may double as a wireless data transmission component using HFA tones), a wired headset or a wireless headset (not illustrated) or other component capable of outputting audio. The device 102 may also optionally include an audio capture component. The audio capture component may be, for example, a microphone 218 or array of microphones, a wired headset or a wireless headset (not illustrated), etc. The microphone 218 may be configured to capture audio (including HFA tones at a frequency that is inaudible to the human ear such that the microphone may double as a wireless data reception component using HFA tones). If an array of microphones is included, approximate distance to a sound's point of origin may be performed acoustic localization based on time and amplitude differences between sounds captured by different microphones of the array. The device 102 (using microphone 218, an optional wake word detection module 220, an optional ASR module 250, an optional NLU module 260, etc.) may be configured to determine audio data corresponding to detected audio. The device 102 (using input/output device interfaces 208, an optional antenna 222, etc.) may also be configured to transmit the audio data to the remote system 108 for further processing.

The antenna(s) 222 (also referred to herein as a “wireless transceiver” 222 may allow for communication between the device 102 and other devices, such as other client devices 102 and/or the remote system 108 via the networks 110. When communicating with other client devices 102, such as between the devices 102(1) and 102(2) in the environment 104 of FIGS. 1A and 1B, the antenna 222 may comprise a wireless LAN (WLAN) (such as WiFi) radio or chip, a Bluetooth (e.g., Bluetooth Low Energy (BLE)) radio or chip, and/or another type of wireless network radio, such as a cellular radio or chip capable of communication with a wireless communication network such as a Long Term Evolution (LTE) network, WiMAX network, 3G/4G/5G network, etc. A wired connection such as Ethernet may also be supported by the device 102. Through the network(s) 110, a speech processing system may be distributed across a networked environment.

With reference again to both FIGS. 2 and 3, the individual devices (102/300) may include an ASR module 250. The ASR module 250 in device 102 (which is purely optional and may be omitted from the device 102) may be of limited or extended capabilities. The ASR module 250 may include language models, and an ASR module 250 that performs the automatic speech recognition process. If limited speech recognition is included, the ASR module 250 may be configured to identify a limited number of words, such as keywords detected by the device, whereas extended speech recognition may be configured to recognize a much larger range of words.

The individual devices (102/300) may include a NLU module 260. The NLU module 260 in device 102 (which is purely optional and may be omitted from the device 102) may be of limited or extended capabilities. The NLU module 260 may comprising a name entity recognition module, an intent classification module, and/or other components. The NLU module 260 may also include a stored knowledge base and/or entity library, or those storages may be separately located. The individual devices (102/300) may also include an optional command processor 290 that is configured to execute commands/functions associated with a spoken command. Multiple devices may be employed in a single speech processing system. In such a multi-device system, individual ones of the devices (102/300) may include different components for performing different aspects of the speech processing. The multiple devices may include overlapping components.

As shown in FIG. 2, the device 102 may include a scanner 255, such as a code capture module configured to capture machine-readable codes including barcodes, quick response (QR) codes, and the like. The scanner 255 may be used to identify items (e.g., products) available from an electronic marketplace provided by the remote system 108. A power supply 265 (e.g., a battery or multiple batteries, solar panel, etc.) may be included in the device 102 to allow for portable use of the device 102 without plugging the device into a power outlet.

It is to be appreciated that the components of the devices 102 and remote device 300, as illustrated in FIGS. 2 and 3, are exemplary, and may be located in a stand-alone device or may be included, in whole or in part, as a component of a larger device or system, may be distributed across a network or multiple devices connected by a network, etc.

The processes described herein are illustrated as a collection of blocks in a logical flow graph, which represent a sequence of operations that can be implemented in hardware, software, or a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes. For discussion purposes, the processes described herein are described with reference to the components of the Figures shown herein.

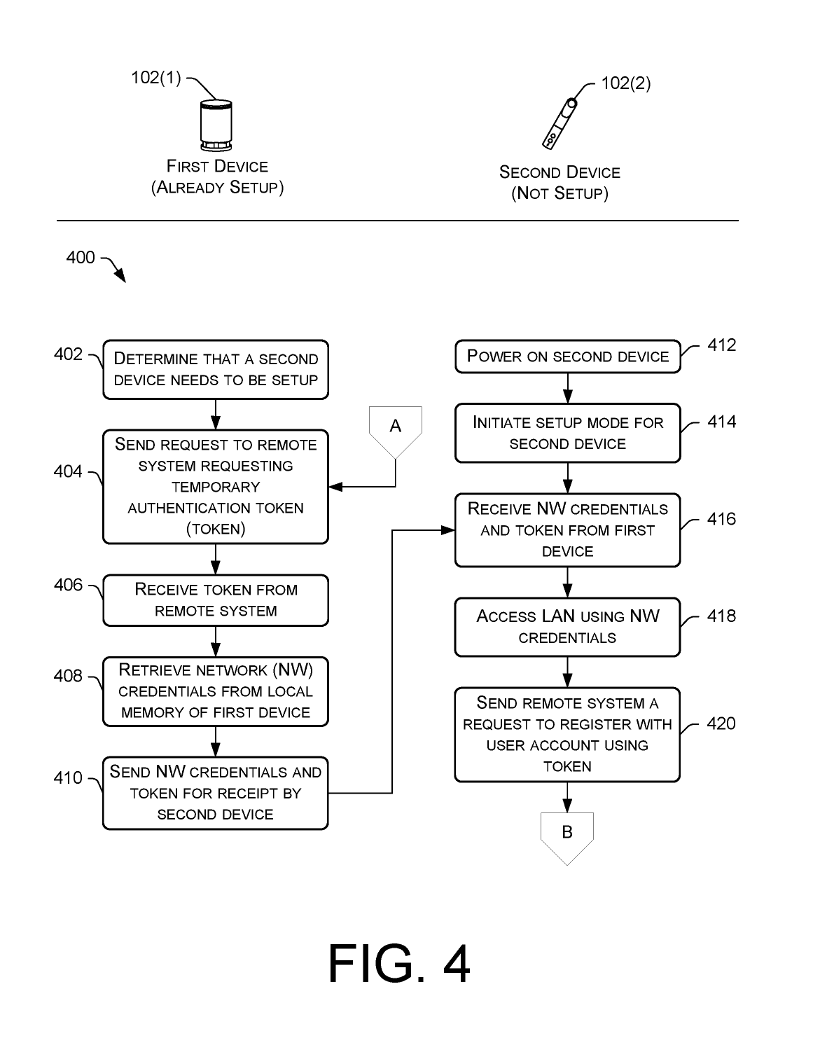

FIG. 4 is a flow diagram of an illustrative process 400 for setting up a secondary device, such as the secondary device 102(2) discussed with reference to FIGS. 1A, 1B, and 2.

At 402, a first device 102(1) may determine that a second device 102(2) needs to be setup. This first device 102(1) may be already setup, meaning that the first device 102(1) has access to a LAN (e.g., a private LAN) in an environment 104 where the first device 102(1) is collocated with the second device 102(2), is authorized to communicate with a remote system 108 using a previously issued authentication token 318. In making the determination at block 402, the first device 102(1) may not be aware of the identity and/or location of the second device 102(2). Rather, the first device 102(1) may be apprised of the fact that a secondary device needs to be setup, not knowing exactly which secondary device needs to be setup or where that secondary device may be located. Examples of different ways of making the determination at block 402 are discussed below herein with reference to the other Figures.

At 404, in response to the first device 102(1) determining, at block 402, that the second device needs to be setup, the first device 102(1) may send a request 120 via a WAP 112 and over a WAN 110 to a remote system 108 requesting a temporary authentication token 122.

At 406, the first device 102(1) may receive the temporary authentication token 122 from the remote system 108 over the WAN 110 and via the WAP 112.

At 408, the first device 102(1) may retrieve, from local memory 114/204 of the first device 102(1), network credentials 116 that provide access to a LAN. The WAP 112 may make the LAN available to devices 102 within the environment 104 where the first and second devices 102(1) and 102(2) are collocated. The network credentials 116 may include at least SSID or a basic SSID (BSSID) of the WAP 112. The network credentials 116 may further include a password associated with the LAN in the case of a private (or secure) LAN that requires a password. The network credentials 116 may further include one or more security keys, such as cryptographic keys, which may allow for private/secure message passing between devices 102 in the environment. In some embodiments, in addition to the network credentials, the first device 102(1) may retrieve additional information from local memory of the first device and/or from the remote system 108, such as a region identifier that tells devices 102 located in the environment 104 which endpoint of the remote system 108 to contact, frequency spectrum information that tells devices which radio frequencies are permitted where the environment 104 is located, and other possible information.

At 410, the first device 102(1) may send, via a wireless data transmission component (e.g., a speaker(s) 216, a wireless transceiver 222, etc.) of the first device 102(1), at least the temporary authentication token 122 and the network credentials 116 for receipt by the second device 102(2) for use in setting up the second device 102(2). Various techniques can be used for sending the setup information at block 410, as discussed herein. As will be described in more detail below, the setup information (e.g., the temporary authentication token 122 and the network credentials 116) can be broadcast via a wireless transceiver 222 or a speaker(s) 216 of the first device 102(1), sent directly to the second device 102(2) via a wireless transceiver 222, and the like. In some embodiments, the first device 102(1) may send the additional information noted above with reference to block 410, such as the region identifier, the frequency spectrum information, and the like. In some configurations, the setup information is encrypted (e.g., using a pre-shared key that is known to both devices 102(1) and 102(2)) before sending for added security.

At 412, the second device 102(2) that is to be setup may be powered on. This may include the user 106 plugging the second device 102(2) into a power outlet, inserting a battery or multiple batteries into a battery compartment, and/or providing user input (e.g., pressing a button on the second device 102(2), uttering a voice command “Setup,” etc.) to the second device 102(2). It is to be appreciated that block 412 may be performed before, during, or after any of the blocks 402-410.

At 414, the second device 102(2) may initiate a setup mode for the second device 102(2). The second device 102(2) may automatically initiate setup mode upon being powered on at block 412, or may initiate the setup mode in response to user input provided to the second device 102(2), as discussed above with reference to block 412.

At 416, the second device 102(2) may receive, via a wireless data reception component (e.g., a speaker(s) 216, a wireless transceiver 222, etc.) of the second device 102(2), the temporary authentication token 122 and the network credentials 116 sent by the first device 102(1).

At 418, the second device 102(2) may access the LAN in the environment 104 where the first and second devices 102(1) and 102(2) are collocated using the network credentials 116 received from the first device 102(1).

At 420, the second device 102(2) may send a request via the WAP 112 and over the WAN 110 to the remote system 108 requesting to register, using the temporary authentication token 122, the second device 102(2) with a user account of the user 106 associated with the first and second devices 102(1) and 102(2).

Notably, the process 400 involves minimal user interaction, such as significantly less user interaction compared to that which is typically required to setup devices using existing setup techniques. For instance, a user 106 does not have to recall or input a private LAN password in order to setup the second device 102(2) for use with the remote system 108. The user 106 also does not have to own a smart device (e.g., a smart phone or tablet) with a display in order to setup the second device 102(2). Instead, the user 106 may simply place the second device 102(2) within the environment 104 where the already-setup first device 102(1) is located, and power on the second device 102(2) to initiate the process 400. In some cases, the determination at block 402 may involve minimal user input, such as a voice command or a button press. In these example scenarios, the extent of user interaction is significantly reduced to create a simplified setup process where most of the setup operations are carried out by the devices 102 within the environment 104.

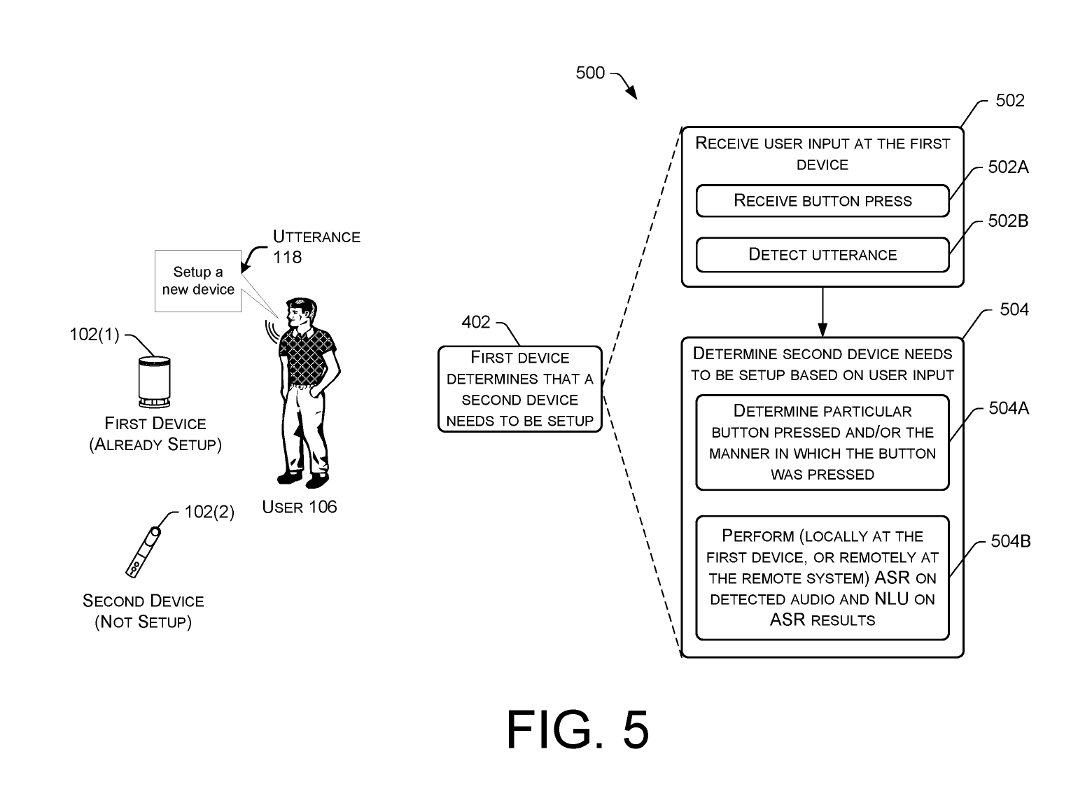

FIG. 5 is a flow diagram of an illustrative process 500 for the first device 102(1) determining that a second device 102(1) needs to be setup. As shown in FIG. 5, the process 500 may represent an example sub-process of block 402, which was described with reference to the process 400 of FIG. 4.

At 502, the first device 102(1) may receive user input from a user 106, the user input indicating that the second device 102(2) has been requested to be setup. The user input received by the first device 102(1) at block 502 may exclude user input that involves the user 106 entering (e.g., typing) network credentials (e.g., a WiFi password) into the first device 102(1), and in some cases the first device 102(1) is not configured to receive such user input because the first device 102(1) may not include a keyboard or a touchscreen. In some cases, the user input received by the first device 102(1) at block 502 may exclude user input that involves requesting to download a mobile application to the first device 102(1). The user input received by the first device 102(1) at block 502 may, by contrast, represent a type of user input that requires little effort on the part of the user 106 to provide to the first device 102(1).

FIG. 5 shows, at block 502A, that the user input received by the first device 102(1) at block 502 may include the first device 102(1) detecting an actuation of a button and/or that the actuation of the button occurs in a particular manner. For example, the first device 102(1) may include a button that, upon actuation, indicates to the first device 102(1) that a secondary device needs to be setup. In another example, the manner in which the actuation of the button occurs may indicate to the first device 102(1) that a secondary device needs to be setup. In this manner, an existing button that is used for other purposes may be pressed and held for a predetermined period of time (e.g., pressed and held for a few seconds) to indicate to the first device 102(1) that a secondary device needs to be setup. Configuring the first device 102(1) in this way may reduce manufacturing costs so that an extra button does not have to be implemented on the first device 102(1) for use in setting up a secondary device.

Block 502B shows another example type of user input that may be received at block 502; namely, an utterance 118 detected by, or received via, a microphone(s) 218 of the first device 102(1). For example, the user 106 might utter the voice command “Setup a new device” (possibly with a predefined “wake word”) to indicate to the first device 102(1) that a secondary device needs to be setup.

At 504, the first device 102(1) may determine that a secondary device needs to be setup based at least in part on the user input received at block 502. FIG. 5 shows, at block 504A, when the first device 102(1) detects actuation of a button at 502A, that a particular button for setting up a secondary device was actuated, and/or that the particular button was actuated in a particular manner (e.g., pressed and held for a few seconds) to indicate to the first device 102(1) that a secondary device needs to be setup.

Block 504B shows another example when the microphone(s) 218 of the first device 102(1) detects an utterance 118 from the user. At block 504B, the first device 102(1) may use ASR and NLU techniques to determine that a secondary device needs to be setup. This may be done locally at the first device 102(1) if the first device 102(1) is configured with an onboard ASR module 250, NLU module 260, and command processor 290. Alternatively, the first device 102(1) may transmit data to the remote system 108 to perform some or all of the ASR and NLU techniques, such as by recording audio data upon detection of a predefined wake word, and sending the audio data to the remote system 108, which processes the audio data through Cloud-based ASR and NLU components.

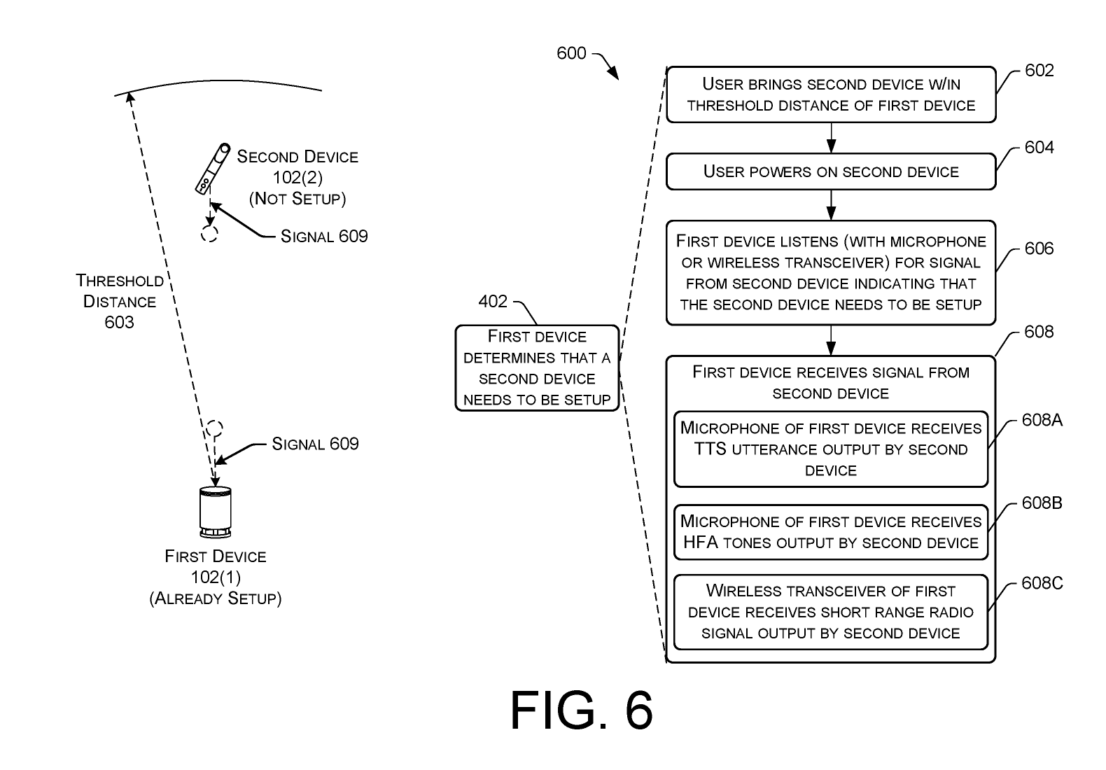

FIG. 6 is a flow diagram of another illustrative process 600 for the first device 102(1) determining that a second device needs to be setup. As shown in FIG. 6, the process 600 may represent another example sub-process of block 402, which was described with reference to the process 400 of FIG. 4.

At 602, a user 106 may bring the second device 102(2) within a threshold distance 603 of the first device 102(1). The threshold distance 603 may vary depending upon the wireless data transfer technique and/or protocol used to transfer information/data between the two devices 102(1) and 102(2). In some embodiments, the second device 102(2) may utilize its speaker(s) 216 as a wireless data transmission component to output a signal in the form of a TTS output or one or more HFA tones, and the first device 102 may utilize its microphone(s) 218 to receive the audio that is output from the speaker(s) 216 of the second device 102(2). In this scenario, the threshold distance may be about 10 meters (m). The range at which the devices 102(1) and 102(2) can communicate over their respective speaker(s) 216 and microphone(s) 218 may vary depending on external factors, including environmental noise (indoor vs. outdoor environments 104), whether any obstructions/objects (e.g., walls) are disposed between the devices 102(1) and 102(2), and the like. In some embodiments, bringing the second device 102(2) within a threshold distance of the first device 102(1) may further include placing the second device 102(2) within the same room of a structure (e.g., a room of a house) as the first device 102(1). In configurations where the devices 102(1) and 102(2) are configured to communicate using respective wireless transceivers 222, the threshold distance may depend on the communication protocol employed. For instance, with Bluetooth protocols, the threshold distance may be about 50 m, or even greater (e.g., 100 m), depending on the type of radio chip utilized, frequency spectrum utilized, and external factors. Bluetooth Low Energy (BLE) is an exemplary wireless communication protocol that can be utilized to transmit signals and/or information/data between the devices 102(1) and 102(2) in the environment 104. BLE systems may use short wavelength radio transmissions in the 2.4 gigahertz (GHz) Industrial, Scientific, and Medical (ISM) band at 2400-2483.5 megahertz (MHz) and may use 40 radio frequency (RF) channels that are 2 MHz wide. BLE can use a radio technology called frequency-hopping spread spectrum which chops up the data being sent and transmits chunks of it on the different channels. BLE can also have an over-the-air data rate of about 1 megabit per second (Mb/s), and a power consumption that is a fraction of the power consumption of Classic Bluetooth.

At 604, the user 106 may power on the second device 102(2). This may involve the user 106 plugging in the second device 102(2) to a power outlet, inserting a battery (or batteries) into the second device 102(2), and/or pressing a button on the second device 102(2) to power on the second device 102(2).

At 606, the first device 102(1) may “listen” for a signal from the second device by activating a microphone(s) 218 of the first device 102(1) and/or with use of a wireless transceiver 222 of the first device 102(1) (e.g., a Bluetooth radio or chip). In some configurations, the first device 102(1) may periodically activate the microphone(s) 218 to listen for the signal, or it may wait for an event (e.g., a predefined signal, user input, and/or “wake word”) to begin listening for the signal. In some configurations, the first device 102(1) may “ping” the second device 102(2) with one or more HFA tones or a Bluetooth signal, and may subsequently listen for a return signal from the second device 102(2) at block 606.

At 608, the first device 102(1) may receive a signal 609 from the second device 102(2), the signal indicating to the first device 102(1) that the second device 102(2) needs to be setup. As shown at 608A, the signal received at block 608 may include a TTS utterance output by the second device 102(2) and received via the microphone(s) 218 of the first device 102(1). For example, the second device 102(2) may be configured to output a TTS utterance via the speaker(s) 216 of the second device 102(2), such as “Set me up” (possibly along with a predefined “wake word”). As shown at 608B, the signal received at block 608 may include one or more HFA tones output via the speaker(s) 216 of the second device 102(2) at a frequency that is inaudible to a human ear, and received via the microphone(s) 218 of the first device 102(1). As shown at 608C, the signal received at block 608 may include a wireless radio signal (e.g., packets via Bluetooth), which are output by the wireless transceiver 222 of the second device 102(2), and received via the wireless transceiver 222 of the first device 102(1). In some cases, such as with Bluetooth, the range of the wireless radio signal received at 608C may be no greater than about 100 meters, which highlights why the second device 102(2) is to be placed within the threshold distance 603 of the first device 102(1) at block 602.

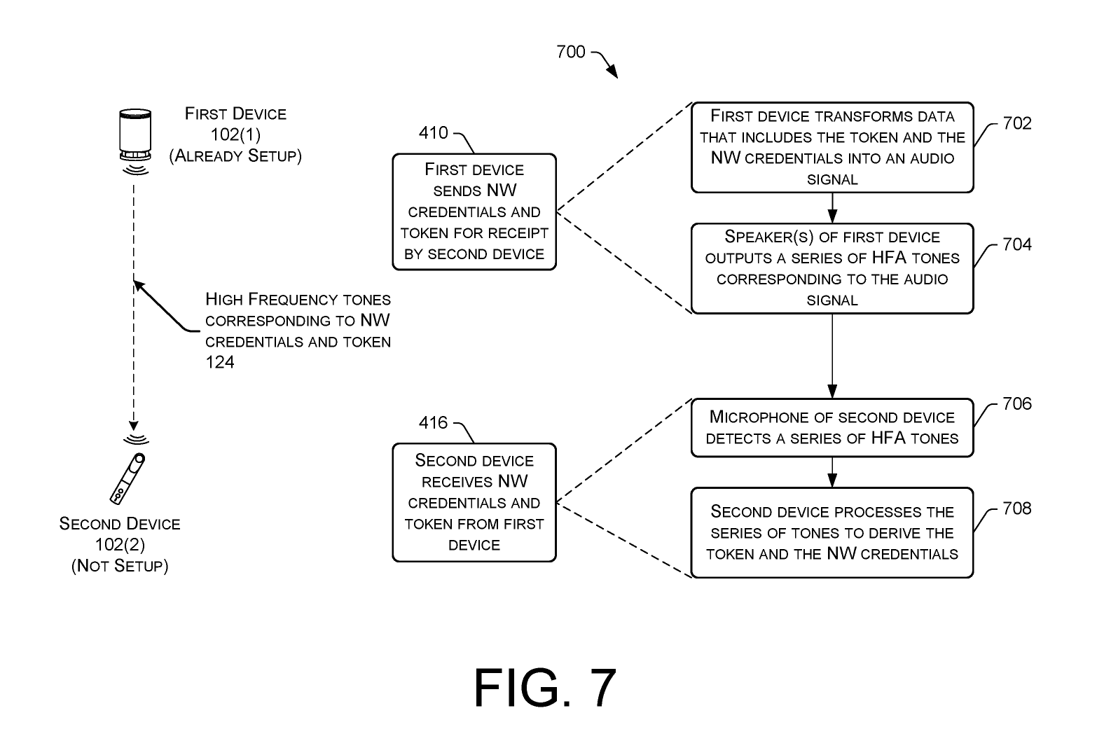

FIG. 7 is a flow diagram of an illustrative process 700 for the first device 102(1) sending, and the second device 102(2) receiving, network credentials 116 and a temporary authentication token 122 for use in setting up the second device 102(2). As shown in FIG. 7, the process 700 may represent example sub-processes of blocks 410 and 416, which were described with reference to the process 400 of FIG. 4.

At 702, in order to send the network credentials 116 and the temporary authentication token 122 (i.e., setup information for use by the second device 102(2)), the first device 102(1) may transform data that includes the temporary authentication token 122 and the network credentials 116 into an audio signal. In some configurations, the transformation of the data at 702 may include transforming the data into a modulated signal that is to be output at a frequency that is inaudible to a human ear (e.g., a frequency that is greater than about 20 kHz). It is to be appreciated that additional data or information may be transformed at block 702 into the audio signal, such as the aforementioned region identifier, the frequency spectrum information, and the like, so that the additional data or information can be sent along with the temporary authentication token 122 and the network credentials 116.

At 704, the first device 102(1) may outputting a series of tones corresponding to the audio signal created at block 702 via a speaker(s) 216 of the first device 102(1). The series of tones output at block 704 may be HFA tones, meaning that the series of tones are output at the frequency that is inaudible to the human ear. In some configurations, the HFA tones output at block 704 may be preceded by one or more predefined tones that act as a trigger mechanism for the second device 102 to start decoding the tones following the one or more initial, predefined tones. Depending on the amount of information sent, the payload of data output in the series of tones may be any suitable number of bits/bytes. To operate within bandwidth constraints of HFA, the temporary authentication token 122 may be fewer characters than a typical permanent authentication token 127, such as a 12 character temporary token 122. Notably, the first device 102(1) does not have to know the identity of the second device 102(2) or even the presence or location of the second device 102(2) in the environment 104 because the HFA tones are more or less broadcast from the speaker(s) 216 of the first device 102(1). So long as the second device 102(2) is within a threshold distance corresponding to a maximum transmission range of the HFA tones, the second device 102(2) is capable of receiving the temporary token 122 and the network credentials 116. As will be described in more detail below, the sending of the temporary authentication token 122 and the network credentials 116 at block 410 may be repeated for some timeout period that is measured by a predetermined period of time and/or a predetermined number of broadcasts. This may ensure that if the second device 102(2) is powered on after an initial broadcast, or if the second device 102(2) fails to receive the initial broadcast for some reason (e.g., interference, noise, etc.), the second device 102(2) may still have an opportunity to receive the setup information in a subsequent broadcast.

At 706, the microphone(s) 218 of the second device 102(2) may detect a series of HFA tones, such as a series of tones at a frequency that is inaudible to a human ear (e.g., a frequency that is greater than about 20 kHz). As mentioned, the second device 102(2) may, upon initiating a setup mode, be configured to open up its microphone(s) 218 to listen for the HFA tones (which may be preceded by one or more predefined HFA tones that act as a trigger for the second device 102(2) to begin decoding the subsequent HFA tones it receives via the microphone(s) 218).

At 708, the second device 102(2) (using the controller(s)/processor(s) 202) may process the series of tones detected by the microphone(s) 218 at block 706 to derive the temporary authentication token 122 and the network credentials 116, such as by a decoding technique that decodes the HFA tones into digital data that includes the token 122 and the network credentials 116.

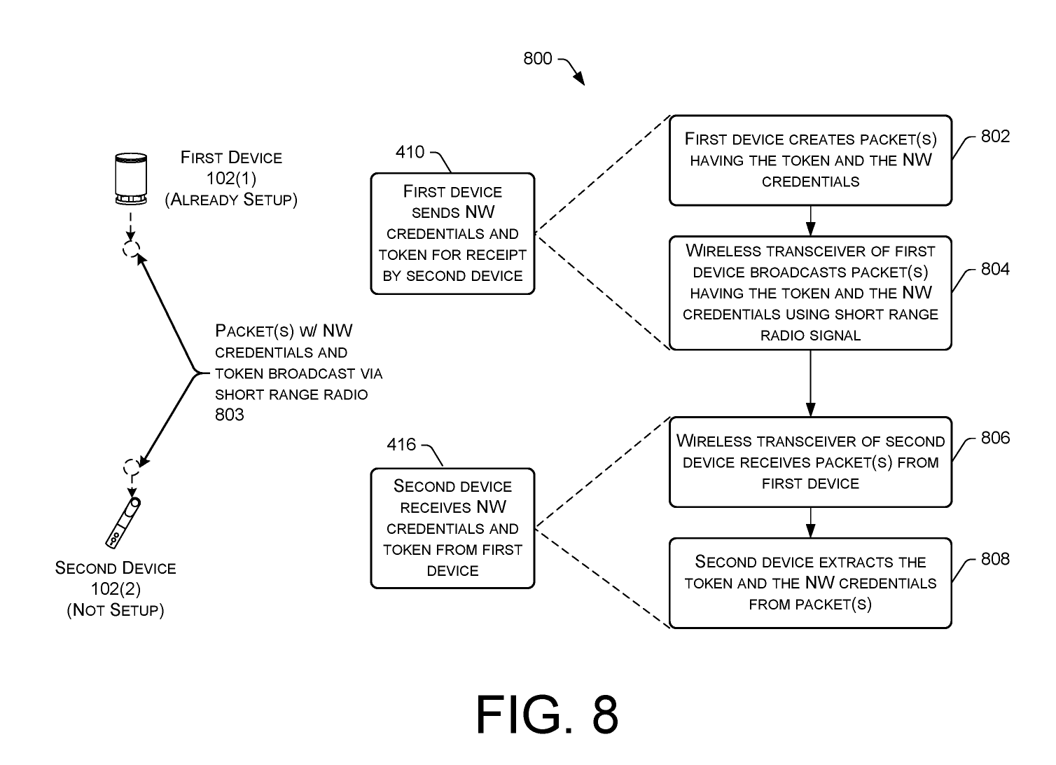

FIG. 8 is a flow diagram of another illustrative process 800 for the first device 102(1) sending, and the second device 102(2) receiving, network credentials 116 and a temporary authentication token 122 for use in setting up the second device 102(2). As shown in FIG. 8, the process 800 may represent other example sub-processes of blocks 410 and 416, which were described with reference to the process 400 of FIG. 4.

At 802, in order to send the network credentials 116 and the temporary authentication token 122 (i.e., setup information for use by the second device 102(2)), the first device 102(1) may create one or more packets 803, having (or carrying) the temporary authentication token 122 and the network credentials 116. This may include creating a packet(s) 803 with a payload that includes the token 122 and the network credentials 116, and possibly additional information, such as the region identifier, the frequency spectrum information, and the like.

At 804, the first device 102(1) may broadcast the packet(s) 803, having (or carrying) the temporary authentication token 122 and the network credentials 116, via a wireless transceiver 222 of the first device 102(1), such as via a short range wireless protocol radio or chip (e.g., Bluetooth radio or chip). For example, the broadcast packets 803 may have a maximum broadcast range of about 100 m.

At 806, the second device 102(2) may receive the packet(s) 803, having (or carrying) at least the temporary authentication token 122 and the network credentials 116 via a wireless transceiver 222 of the second device 102(2), such as via a short range wireless protocol radio or chip (e.g., Bluetooth radio or chip).

At 808, the second device 102(2) (using the controller(s)/processor(s) 202) may extract the temporary authentication token 122 and the network credentials 116 from the received packet(s) 803.

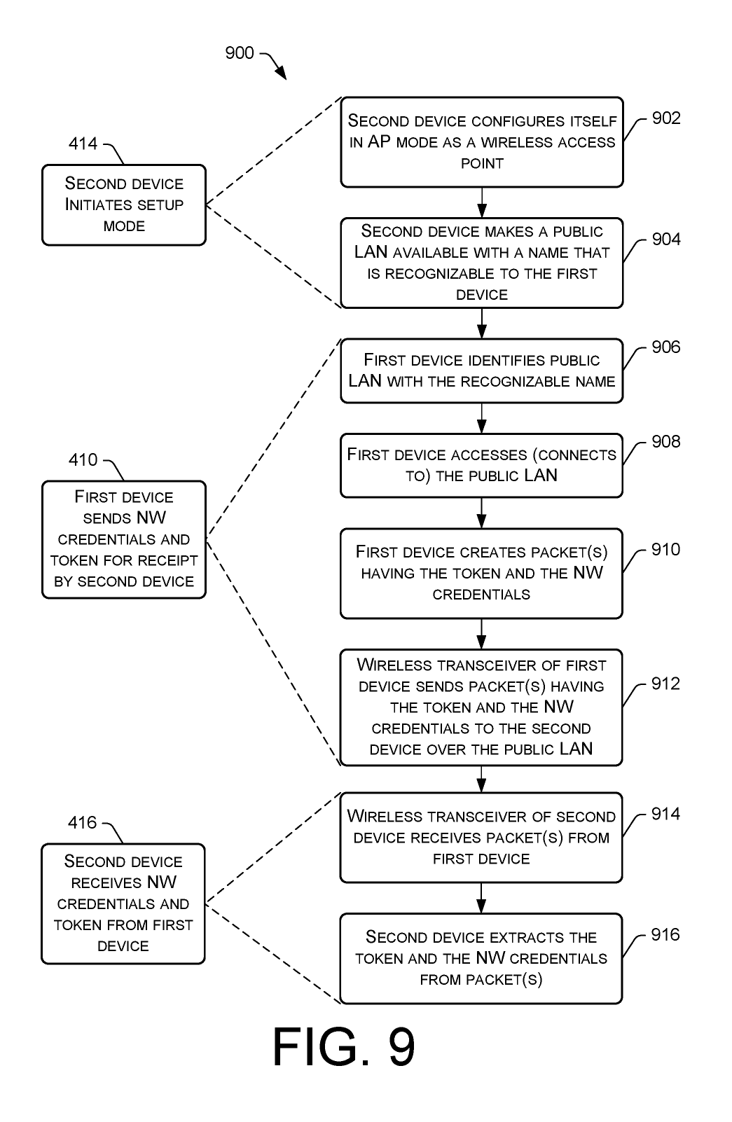

FIG. 9 is a flow diagram of another illustrative process 900 for the first device 102(1) sending, and the second device 102(2) receiving, network credentials 116 and a temporary authentication token 122 for use in setting up the second device 102(2). As shown in FIG. 9, the process 900 may represent other example sub-processes of blocks 410, 414, and 416, which were described with reference to the process 400 of FIG. 4.

At 902, in response to the second device 102(2) initiating a setup mode, the second device 102 may configure itself as a WAP in the environment 104 by allowing other devices 102 in the environment 104 to couple to the WAN 110 via the second device 102(2).

At 904, the second device 102(2), acting as a WAP, may make available a public LAN that does not require a password to access. The name (e.g., SSID) of the public LAN may be chosen as a name that is recognizable to the first device 102(1), such as by defining a name with a predefined pattern of alphanumeric characters that the first device 102(1) is configured to recognize.

At 906, the first device 102(1) may identify a public LAN with a name recognized by the first device 102(1). For example, the first device 102(1) may maintain, in local memory, a predefined sequence of alphanumeric characters, and may look for a public LAN in the environment using a wireless transceiver (e.g., WiFi radio or chip) with a sequence of characters that match (or substantially match, by including at least a threshold number of matching alphanumeric characters) the predefined sequence.

At 908, the first device 102(1) may access the public LAN with the recognizable name.

At 910, the first device 102(1) may create one or more packets having (or carrying) the temporary authentication token 122 and the network credentials 116. This may include creating a packet(s) with a payload that includes the token 122 and the network credentials 116, and possibly additional information, such as the region identifier, the frequency spectrum information, and the like.

At 912, the first device 102(1) may send the packet(s), having (or carrying) the temporary authentication token 122 and the network credentials 116, via a wireless transceiver 222 of the first device 102(1) to the second device 102(2) over the public LAN. For example, the first device 102(1) may send the packet(s) via a wireless protocol radio or chip (e.g., WiFi radio or chip).

At 914, the second device 102(2)—still acting as a WAP in the environment 104—may receive the packet(s) from the first device 102(1) via a wireless transceiver 222 of the second device 102(2), such as via WiFi radio or chip.

At 916, the second device 102(2) (using the controller(s)/processor(s) 202) may extract the temporary authentication token 122 and the network credentials 116 from the received packet(s) received at block 914.

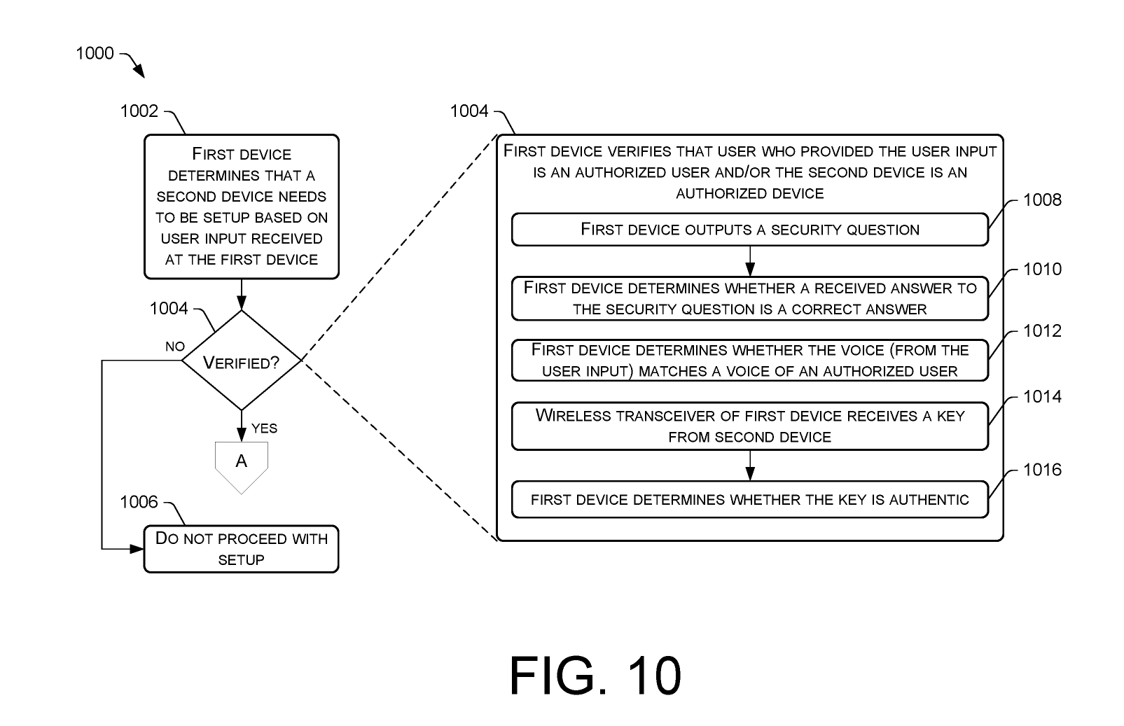

FIG. 10 is a flow diagram of an illustrative process 1000 for the first device 102(1) verifying an authorized user 106 and/or an authorized secondary device 102(2) before proceeding with the setup of the second device 102(2).

At 1002, the first device 102(1), based at least in part on user input (e.g., a voice command) received at the first device 102(1), may determine that a secondary device needs to be setup. Block 1002 may include operations similar to those described with reference to the process 500 of FIG. 5.

At 1004, the first device 102(1) may determine whether the user 106 who provided the user input is an authorized user associated with a user account with which the secondary device is to be registered, and/or whether the secondary device to be setup is an authorized device that is to be associated with the user account. If the user 106 and/or secondary device are verified as being an authorized user and/or device, the process 1000 may follow the “yes” route from block 1004, via off-page reference “A” to block 404 of the process 400 to carry out the remainder of the process 400, as described with reference to FIG. 4, for setting up the secondary device. If, on the other hand, the user 106 and/or secondary device are not verified as being authorized at block 1004, the process 1000 may follow the “no” route from block 1004 to block 1006, where the first device 102(1) refrains from proceeding with a setup for the secondary device. Thus, the process 1000 may act as a security measure that ensures an unauthorized user and/or device cannot be setup.

The verification at block 1004 may include various sub-operations, including, at 1008, the first device 102(1) outputting a security question via the speaker(s) 216 of the first device 102(1). The security question output at block 1008 may ask a user 106 to answer a security question that only that user 106 would know, and/or provide a numerical code or personal identification number (PIN).

At 1010, the first device 102(1) may receiving an utterance via the microphone(s) 218 of the first device 102(1) and determine whether the additional utterance corresponds to a correct answer to the security question. This may involve at least some interaction between the first device 102(1) and the remote system 108 to select a security question associated with the user account and to determine a correct answer(s) to the security question at block 1010.

At 1012, as an additional or alternative verification technique, the first device 102(1) may determine that the voice in the audio data recorded from the user input matches a voice of an authorized user. Voice identification/matching techniques known to a person having ordinary skill in the art may be used for this purpose. For instance, if the user 106 utters “Setup a new device,” the first device 102(1) may use voice identification/matching software to determine whether the voice in the audio data matches a pre-recorded voice of a known, authorized user 106.

At 1014, as an additional or alternative verification technique, the first device 102(1) may receive a key from the second device 102(1) in the environment 104, which is the secondary device to be setup. The key may be stored (e.g., hard coded) in the second device 102(2) at a time of manufacture of the second device 102(2), and used as a verification mechanism so that a device without the predefined key is unable to be setup using the first device 102(1). The key may be transmitted to the first device 102(1) using any of the wireless data transmission techniques and/or protocols described herein.

At 1016, the first device 102(1) may determine whether the key received from the second device 102(2) is authentic (e.g., if it matches a known, predefined key). Accordingly, the process 1000 may ensure that an unauthorized user cannot setup a secondary device and/or that an unauthorized secondary device cannot be setup using the first device 102(1). This provides added security to the setup techniques described herein.

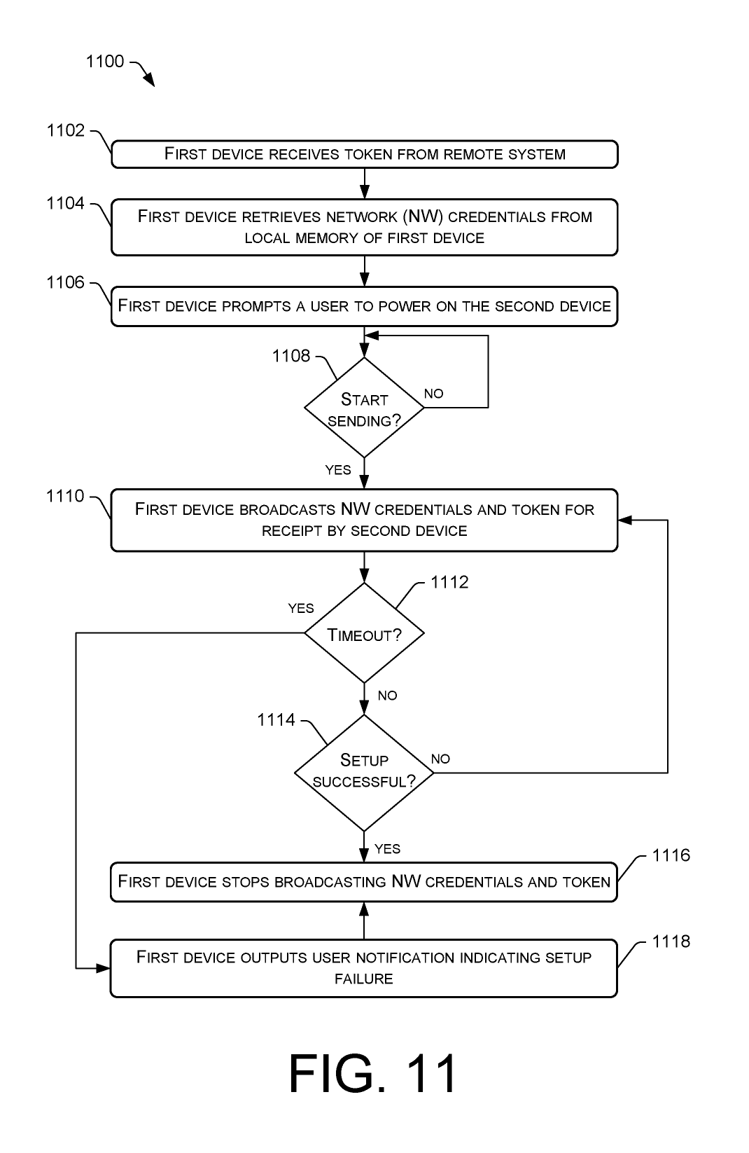

FIG. 11 is a flow diagram of an illustrative process 1100 for the first device 102(1) conserving resources in regards to broadcasting network credentials 116 and a temporary authentication token 122, and terminating a setup procedure for the second device 102(2).

At 1102, the first device 102(1) may receive a temporary authentication token 122 from the remote system 108 over the WAN 110 and via the WAP 112. The operations performed at block 1102 may be similar to those performed at block 406, which was described with reference to the process 400 of FIG. 4. Also, block 1102 may occur after the first device 102(1) determines that a secondary device needs to be setup, and in response to requesting the temporary authentication token 122 from the remote system 122.

At 1104, the first device 102(1) may retrieve, from local memory 114/204 of the first device 102(1), network credentials 116 that provide access to a LAN (e.g., a private LAN). The operations performed at block 1104 may be similar to those performed at block 408, which was described with reference to the process 400 of FIG. 4.

At 1106, the first device 102(1) may prompt a user to power on the secondary device that is to be setup. This may act as a failsafe measure to ensure that the secondary device is able to receive any data/information transmitted from the first device 102(1) as part of the setup process for the secondary device 102(2). As an example, this prompt may be provided as TTS output via a speaker(s) 216 of the first device 102(1) (e.g., “Please power on your new device”)

At 1108, the first device 102(1) may determine whether it should start sending the temporary authentication token 122 and the network credentials 116 for receipt by the secondary device. This determination may be based on a trigger from the secondary device, and may act as a resource (e.g., power resource, network bandwidth resource, processing resource, etc.) conservation measure to avoid transmitting data before the secondary device is ready to receive the data. For instance, the second device 102(2) may not be ready to receive data until it initiates a setup mode. In response to initiating the setup mode, the second device 102(2) may send a signal (e.g., one or more HFA tones, a Bluetooth signal, etc.) that is received by the first device 102(1) to indicate that the second device 102(2) is ready to receive data. Another trigger mechanism may be a time-based trigger mechanism (e.g., the first device 102(1) may wait a predetermined period of time, such as 10 seconds, before sending data in order to provide the user 106 an opportunity after the prompt at 1106 to power on the second device 102(2)). Until such an event, the process 1100 may iterate by following the “no” route from block 1108 to continue monitoring for the trigger event. Once the first device 102(1) determines that it is to start sending data, the process 1100 may follow the “yes” route from block 1108 to block 1110.

At 1110, the first device 102(1) may broadcast (e.g., via a speaker(s) 216, a wireless transceiver 222, etc.) at least the temporary authentication token 122 and the network credentials 116. The broadcasting operations at block 1110 may be similar to those operations described with reference to block 410 (or any sub-process thereof) that involves broadcasting data in HFA tones, packet(s), and the like.

At 1112, the first device 102(1) may determine whether a timeout has occurred since the initial broadcast at block 1110. The timeout monitored at block 1112 may be measured in any suitable manner, such as by monitoring a predetermine period of time since the initial broadcast at block 1112, whether the setup information has been broadcast a predetermined number of times since the initial broadcast at block 1112, and the like.

If the timeout has not been reached at block 1112, the process 1100 follows the “no” route from block 1112 to block 1114, where the first device 102(1) may determine whether the setup of the secondary device was successful. The determination at block 1114 may be made in various ways. For example, the first device 102(1) may send a request to the remote system 108 to determine whether the temporary authentication token 122 has been claimed. Another example technique for the second device(s) 102(2), upon successfully setting itself up, indicating to the first device 102(1) that the setup was successful. This can be performed by the second device 102(2) outputting, via a speaker(s) 216 of the second device 102(2), one or more HFA tones (i.e., a tone(s) at a frequency that is inaudible to a human ear). Because the first device 102(1) may be broadcasting HFA tones as part of block 1110, each device 102 may be assigned its own spectrum over which to send HFA tones to the other device, which allows for bi-directional communication between the two devices 102(1) and 102(2) without relying on the LAN. For instance, a first spectrum (e.g., range of frequencies) may be reserved for the first device 102(1) to send HFA tones at block 1110, while a second, different spectrum (e.g., range of frequencies) may be reserved for the second device 102(2) to send one or more HFA tones to indicate a successful setup at block 1114.

In any case, if the first device 102(1) determines that the setup of the second device 102(2) was successful (e.g., by determining that the temporary token 122 was claimed, and/or by receiving a signal from the second device 102(2)), the process 1100 may follow the “yes” route from block 1114 to block 1116, where the first device 102(1) may stop broadcasting the setup information. This may conserve resources (e.g., power resources, network bandwidth resources, processing resources, etc.) by refraining from broadcasting the setup information when the second device 102(2) has already used it to successfully set itself up.

If, at block 1114, the first device 102(1) determines that the setup of the second device 102(2) has not yet been completed successfully (E.g., by determining that the temporary token 122 has not been claimed, and/or by not receiving a signal from the second device 102(2)), the process 1100 may follow the “no” route from block 1114 back to block 1110 where the first device repeats the broadcast of the setup information. This may iterate through blocks 1110-1114 until the timeout is eventually reached (if the setup of the second device doesn't succeed before the timeout), whereby the process 1100 follows the “yes” route from block 1112 to block 1118.

At block 1118, the first device 102(1) may output a user notification (e.g., a TTS user notification via the speaker(s) 216) to indicate that a setup of the second device 102(2) has failed. At this point, the first device 102(1) may stop broadcasting the setup information, as shown by the arrow from block 1118 to block 1116. This also conserves resources by timing out the attempt to setup the secondary device if it is not successful after a period of time, or after a number of broadcasts. The second device 102(2) may also output a user notification if it determines that the setup attempt has not succeeded (e.g., if the second device 102(2) is not configured to operate on 5 gigahertz (GHz) LANs and the LAN is a 5 GHz LAN). This user notification could also be output as a TTS user notification via the speaker(s) 216 of the second device 102(2).

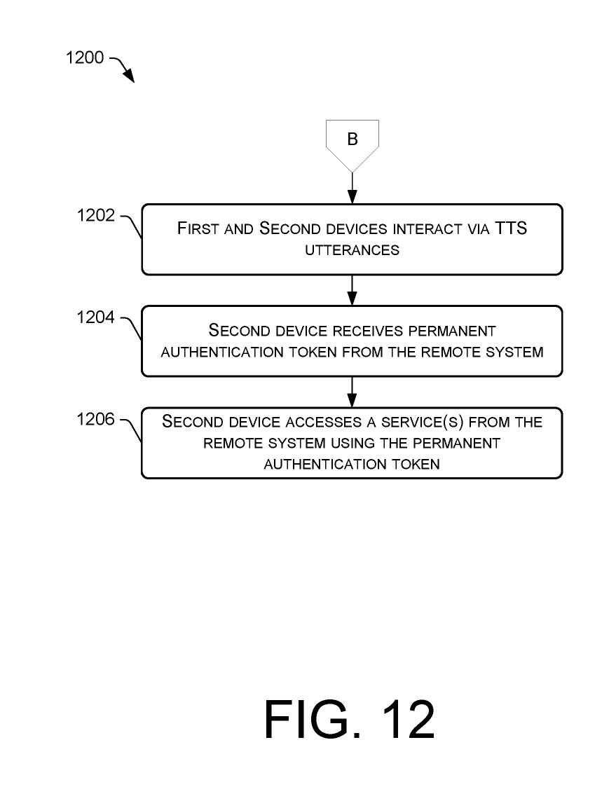

FIG. 12 is a flow diagram of an illustrative process 1200 for notifying a user 106 of a successful setup, and the secondary device 102(2) receiving a permanent authentication token 127, and accessing one or more services from a remote system 108 using the permanent authentication token 127. The process 1200 may continue from block 420 of the process 400, described with reference to FIG. 4, as shown by the off-page reference “B” in FIGS. 4 and 12.

At 1202, the first device 102(1) and the second device 102(2) may interact via TTS utterances to indicate to the user 106 in the environment 104 that the setup of the secondary device 102(2) was successful. An example of this is shown in FIG. 1B where the second device 102(2) provides a first TTS output 128(1), such as “Thanks for setting me up!” (perhaps along with a predefined “wake word” to trigger the first device 102(1) to record the first TTS output 128(1) from the second device 102(2)), and the first device 102(1) responds with a second TTS output 128(2), such as “No problem!”

At 1204, the second device 102(2), having been setup successfully using the temporary token 122 to register with the user account of the user 106, may receive a permanent authentication token 127 from the remote system 108. The permanent token 127 may be larger in size (e.g., more characters corresponding to more bits/bytes of data) than the temporary token 122 and may need to be claimed before expiration of the temporary token 122. This also acts as an added security measure in case any unauthorized devices illicitly snooped on the data transmission between the devices 102(1) and 102(2) and obtained the temporary authentication token 122, rendering the temporary authentication token 122 useless to such a device.

At 1206, the second device 102(2) may access one or more services from the remote system 108 using the permanent authentication token 127. This service(s) can be any type of service provided by the remote system 108, such as an ecommerce service, smart home service, music streaming service, and so on.

It is to be appreciated that the first device 102(1) and the second device 102(2) may be sold and/or serviced by the same entity that operates the remote system 108, but the techniques and systems described herein can be implemented by devices that are sold and/or serviced by different entities associated with different remote systems. For example, the first device 102(1) may be associated with a service providing entity that is associated with the remote system 108, while the second device 102(2) may be associated with a different service providing entity that is associated with a different remote system. In this scenario, the remote system 108 of the first service providing entity may be configured to determine whether the second device 102(2) is associated with a third party service provider, and if so, coordinate with the different remote system of the third party service provider to allow the second device 102(2) to authenticate with the different remote system. Alternatively, the different service providers may agree to an arrangement where a third party secondary device 102(2) is able to access the remote system 108 of the service providing entity associated with the first device 102(1). In any case, the remote system 108 may determine that the secondary device 102(2) is a third party device at a time when the secondary device 102(2) sends a request 126 to the remote system 108 using the temporary authentication token 122. For example, the remote system 108 may ask for a device identifier of the requesting device to determine whether the device is one of its own, or a third party device. Alternatively, first device 102(1) may query the user 106 and/or the secondary device 102(2) to determine whether the secondary device 102(2) is a third party device, and may provide this information to the remote system 108 when the first device 102(1) requests the temporary token 122 from the remote system 108. For instance, in response to receiving the utterance 118 from the user 106 indicating that the secondary device needs to be setup, the first device 102(1) may output a TTS response that asks the user “Are you setting up a Company X device, or a third party device?.” The user 106 may readily know this information and provide it via an additional utterance. If the secondary device 102(2) is queried for this information, the secondary device 102(2) may provide this information to the first device 102(1) using any of the wireless data transmission techniques discussed herein.

The environment and individual elements described herein may of course include many other logical, programmatic, and physical components, of which those shown in the accompanying figures are merely examples that are related to the discussion herein.

Other architectures may be used to implement the described functionality, and are intended to be within the scope of this disclosure. Furthermore, although specific distributions of responsibilities are defined above for purposes of discussion, the various functions and responsibilities might be distributed and divided in different ways, depending on circumstances.

Furthermore, although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. A method comprising:
determining, based at least in part on an utterance received via a microphone of a first device, that a second device has been requested to be setup; and
in response to the determining:
sending, by the first device, a request via a wireless access point (WAP) and over a wide area network (WAN) to a remote system requesting a temporary authentication token, wherein the first device maintains, in local memory of the first device, network credentials to connect to a private local area network (LAN) that includes the WAP, and wherein the first device is registered with a user account to access one or more services from the remote system;
receiving, by the first device, the temporary authentication token from the remote system over the WAN and via the WAP;
retrieving, by the first device, the network credentials from the local memory;
transforming, by the first device, data that includes the temporary authentication token and the network credentials into an audio signal; and
outputting a series of tones corresponding to the audio signal via a speaker of the first device, the series of tones being output at a frequency that is inaudible to a human ear for receipt by the second device for use in setting up the second device.

2. The method of claim 1, further comprising verifying, by the first device and prior to the sending of the request requesting the temporary authentication token, that a user who uttered the utterance is an authorized user associated with the user account by:
outputting a security question via the speaker of the first device;
receiving an additional utterance via the microphone of the first device; and
determining that the additional utterance corresponds to a correct answer to the security question.

3. The method of claim 1, further comprising:
prompting, by the first device and prior to the outputting of the series of tones, a user to power on the second device;
initiating, by the second device and after being powered on, a setup mode for the second device;
detecting, via a microphone of the second device while the second device is in the setup mode, the series of tones output via the speaker of the first device;
deriving, by the second device and from the series of tones, the temporary authentication token and the network credentials;
accessing, by the second device, the private LAN using the network credentials; and
sending, by the second device, a second request via the WAP and over the WAN to the remote system requesting to register the second device with the user account using the temporary authentication token.

4. A system including a first device comprising:
one or more processors;
a wireless data transmission component; and
a memory storing network credentials for access to a local area network (LAN) and computer-executable instructions that, when executed by the one or more processors, cause the first device to:
send a request via a wireless access point (WAP) and over a wide area network (WAN) to a remote system requesting a temporary authentication token;
receive the temporary authentication token from the remote system over the WAN and via the WAP;
retrieve the network credentials from the memory; and
send, via the wireless data transmission component, the temporary authentication token and the network credentials for receipt by a second device for use in setting up the second device.

5. The system of claim 4, wherein the computer-executable instructions, when executed by the one or more processors, cause the first device to determine that the second device needs to be setup based at least in part on at least one of:
user input received by the first device; or
a signal received from the second device.

6. The system of claim 5, wherein:
the first device further comprises a microphone and a wireless transceiver;
the user input comprises an utterance received via the microphone; and
the signal received from the second device comprises at least one of:
a text-to-speech (TTS) utterance output by the second device and received via the microphone;
one or more tones output by the second device at a frequency that is inaudible to a human ear, and received via the microphone; or
a wireless radio signal output by the second device and received via the wireless transceiver.

7. The system of claim 4, wherein:
the wireless data transmission component comprises at least one of:
a wireless transceiver; or
a speaker; and
sending the temporary authentication token and the network credentials via the wireless data transmission component comprises at least one of:
broadcasting one or more packets having the temporary authentication token and the network credentials via the wireless transceiver; or
transforming data that includes the temporary authentication token and the network credentials into an audio signal; and
outputting a series of tones corresponding to the audio signal via the speaker, the series of tones being output at a frequency that is inaudible to a human ear.

8. The system of claim 4, wherein:
the wireless data transmission component comprises a wireless transceiver; and
sending the temporary authentication token and the network credentials via the wireless data transmission component comprises:
identifying a public LAN with a name recognized by the first device;
accessing the public LAN; and
sending one or more packets having the temporary authentication token and the network credentials to the second device via the wireless transceiver and over the public LAN.

9. The system of claim 4, further including the second device, the second device comprising:
one or more second processors;
a wireless data reception component; and
a second memory storing second computer-executable instructions that, when executed by the one or more second processors, cause the second device to:
initiate a setup mode for the second device;
receive, via the wireless data reception component, the temporary authentication token and the network credentials;
access the LAN using the network credentials; and
send a second request via the WAP and over the WAN to the remote system requesting to register, using the temporary authentication token, the second device with a user account.

10. The system of claim 9, wherein:
the wireless data reception component comprises at least one of:
a wireless transceiver; or
a microphone; and
receiving the temporary authentication token and the network credentials via the wireless data reception component comprises at least one of:
receiving one or more packets having the temporary authentication token and the network credentials via the wireless transceiver; or
detecting, via the microphone, a series of tones at a frequency that is inaudible to a human ear; and
processing the series of tones to derive the temporary authentication token and the network credentials.

11. A method comprising:
sending, by a first device, a request via a wireless access point (WAP) and over a wide area network (WAN) to a remote system requesting a temporary authentication token;
receiving, by the first device, the temporary authentication token from the remote system over the WAN and via the WAP;
retrieving, by the first device, network credentials from memory of the first device, the network credentials being usable to access a local area network (LAN); and
sending, by the first device, the temporary authentication token and the network credentials for receipt by a second device for use in setting up the second device.

12. The method of claim 11, wherein the sending of the temporary authentication token and the network credentials comprises at least one of:
broadcasting, via a wireless transceiver of the first device, one or more packets having the temporary authentication token and the network credentials; or
transforming, by the first device, data that includes the temporary authentication token and the network credentials into an audio signal; and
outputting, via a speaker of the first device, a series of tones corresponding to the audio signal, the series of tones being output at a frequency that is inaudible to a human ear.

13. The method of claim 11, further comprising:
prompting, prior to the sending of the temporary authentication token and the network credentials, a user to power on the second device; and
repeating the sending of the temporary authentication token and the network credentials a predetermined number of times, or for a predetermined period of time.

14. The method of claim 13, further comprising:
determining, by the first device and based at least in part on a second request sent by the first device to the remote system, whether the temporary authentication token has been claimed; and
in response to determining that the temporary authentication token has been claimed prior to reaching the predetermined number of times or the predetermined period of time, stopping, by the first device, the repeating of the sending of the temporary authentication token and the network credentials; or
in response to determining that the temporary authentication token has not been claimed after reaching the predetermined number of times or the predetermined period of time, outputting, by the first device, a user notification indicating a failure to setup the second device.

15. The method of claim 11, further comprising:
initiating, by the second device, a setup mode for the second device;
receiving, by the second device, the temporary authentication token and the network credentials;
accessing, by the second device, the LAN using the network credentials; and
sending, by the second device, a second request via the WAP and over the WAN to the remote system requesting to register, using the temporary authentication token, the second device with a user account.

16. The method of claim 15, further comprising:
receiving, by the second device and in response to successfully registering the second device with the user account, a permanent authentication token from the remote system; and
accessing, by the second device, a service from the remote system using the permanent authentication token.

17. The method of claim 15, further comprising indicating, by the second device, a successful setup to the first device by outputting, via a speaker of the second device, one or more tones at a frequency that is (i) inaudible to a human ear and (ii) within a second spectrum reserved for the second device to send the one or more tones, the second spectrum being different from a first spectrum reserved for the first device to send other tones at another frequency that is inaudible to the human ear.

18. The method of claim 11, further comprising:
refraining, by the first device, from the sending of the temporary authentication token and the network credentials until a signal is received from the second device; and
receiving, by the first device, the signal to initiate the sending,
wherein the sending of the temporary authentication token and the network credentials occurs in response to the receiving of the signal from the second device.

19. The method of claim 11, further comprising:
determining that the second device needs to be setup based at least in part on at least one of:
an utterance received via a microphone of the first device; or
a signal received from the second device, the signal received from the second device comprising at least one of:
a text-to-speech (TTS) utterance output by the second device and received via the microphone of the first device;
one or more tones output by the second device at a frequency that is inaudible to a human ear, and received via the microphone of the first device; or
a wireless radio signal output by the second device and received via a wireless transceiver of the first device.

20. The method of claim 11, wherein:
the LAN is a private LAN; and
the network credentials include a service set identifier (SSID) of the private LAN and a password to access the private LAN.
